(19) United States
(12) Patent Application Publication
(10) Pub. No.: US 2009/0014920 A1
(43) Pub. Date: Jan. 15, 2009

(54) POLYMER FILAMENTS

(75) Inventors: Warwick John Belcher, New Castle (AU); Alan Graham MacDiarmid, Philadelphia, PA (US); David Leslie Officer, Wollongong (AU); Simon Berners Hall, Palmerston North (NZ)

Correspondence Address: KENYON & KENYON LLP, ONE BROADWAY, NEW YORK, NY, 10004, US

(73) Assignee: MASSEY UNIVERSITY, Palmerston North (NZ)

(21) Appl. No.: 11/630,592

(22) PCT Filed: Jun. 24, 2005
(86) PCT No.: PCT/NZ2005/000143

§ 371 Date: Mar. 5, 2008

(30) Foreign Application Priority Data
Jun. 24, 2004 (NZ) 533796

(51) Int. Cl. C08L 71/02; C08F 226/06; C08F 228/06; B29C 47/00

(52) U.S. Cl. 264/465; 525/187; 526/258; 526/256

(57) ABSTRACT

The invention relates to polymer filaments and methods for their production. In particular, although not exclusively, the invention relates to conducting polymer filaments and their production from solutions of polymerisable oxidizable monomer units.

### FIELD OF INVENTION

The invention relates to polymer filaments and methods for their production. In particular, although not exclusively, the invention relates to conducting polymer filaments and their production from solutions of polymerisable oxidizable monomer units.

### BACKGROUND

Polymers and their application is a well established science and conducting polymers in particular have become of great importance since their discovery in the 1970s. There is hardly an aspect of modern life which does not involve the use of polymers with various properties and of various forms. There is a rapidly increasing market for usable polymeric materials, in particular conducting polymers.

One of the major problems associated with polymer chemistry is that of processing the polymers in order to convert them into usable materials. This is particularly important in the area of conducting polymers where most polymers are insoluble in standard solvents.

Conducting polymer films have a number of applications. These include use as corrosion preventive materials for metal surfaces, coating materials to prevent oxidation deterioration of semiconductors, transparent electrodes formed by coating the film on a transparent material such as glass plate or polymer film or electro chromic materials, switching components, galvanic cells, capacitors or dielectrics.

The introduction of functionality provides a conducting polymer film which can be used in or for a wide variety of applications including; electronic devices, piezo-electric elements, light-energy conversion, electro-optics, light modulators or optical modulators, electrochromics, photochromics, photo memories, solvatochromics, separation membranes, polymer catalysts or biopolymer catalysts.

Conducting polymer filaments have use in a number of applications not provided for by the use of conducting polymer films. These include uses as “molecular wires” for the development of nano-scale electronic devices. Mats of conducting polymer filaments may be developed as high surface area electrodes for sensor and photovoltaic applications.

The production of a polymer may be achieved by one of two polymerisation methods; electropolymerisation or chemical polymerisation. In electropolymerisation polymer films may be formed in situ. However, applying this method of preparation on an industrial scale is problematic.

In chemical polymerisation the polymerisation reaction is initiated when an oxidant is contacted with a polymerisable monomer. Known methods for the preparation of polymer films by chemical polymerisation may be broadly classified according to how the initiation of polymerisation is controlled.

The first of these classes of chemical polymerisation involves the contacting of a monomer in the gas phase with an oxidising agent in the liquid phase. The second of these classes of chemical polymerisation includes the contacting of a polymerisable monomer in the gas or liquid phase with an oxidising agent that forms part of the resin moulding.

The third class of chemical polymerisation includes the mixing of a polymerisable monomer and oxidising agent in the liquid phase and immediate application to a substrate. The fourth class of chemical polymerisation is similar to the third class of chemical polymerisation, but with the intermediate step of removal of any precipitate formed following mixing and prior to application to a substrate.

These classes of chemical polymerisation are outlined in the specification for U.S. Pat. No. 5,306,443. A particular method for the preparation of conducting polymer films is described in which a supposedly homogenous stable precursor solution containing both polymerisable monomer and oxidant is used. The solution is applied to a substrate and dried resulting in the formation of a polymer film.

In the method of preparing conducting polymer films described in U.S. Pat. No. 5,306,443 the mixture of polymerisable monomer and oxidising agent in solution is applied to a substrate solvent. Removal of solvent may be facilitated by warming in a drying oven or vacuum-drying oven. In this method of preparing a conducting polymer film the removal of solvent is not rapid. Nor is it a requirement that the formation of polymer is near instantaneous as the solvent is removed. Known polymerisation methods for the preparation of polymer films are not readily applicable to the preparation of polymer filaments.

Discovered in the 1920s, electrospinning has only recently been applied to the preparation and processing of polymer filaments including nanofibres. These methods have used preformed polymers. A typical procedure for the preparation of polymer filaments uses a solution of the preformed polymer.

Electrospinning uses electrical forces to produce polymer filaments with nanometre-scale diameters. Electrospinning occurs when the electrical forces at the surface of a polymer solution overcome the surface tension and cause an electrically charged jet to be ejected. When the jet dries or solidifies, an electrically charged filament remains. This charged filament can be directed or accelerated by electrical forces and then collected.

For reviews of electrospinning and the applications of polymer filaments see: Reneker, Darrell H.; Chun, Iksoo, Nanotechnology (1996), 7(3), 216-223; Gibson, Phillip; Schreuder-Gibson, Heidi; Pentheny, Christopher, Journal of Coated Fabrics (1998), 28 (July), 63-72; Bognitzki, Michael; Czado, Wolfgang; Frese, Thomas; Schaper, Andreas; Hellwig, Michael; Steinhart, Martin; Greiner, Andreas; Wendroff, Jouchim H., Advanced Materials (Weinheim, Germany) (2001), 13(1), 70-72; Buer, A.; Ugbolue, S. C.; Warner, S. B., Textile Research Journal (2001), 71(4), 323-328; Fong, Hao; Reneker, Darrell H., Structure Formation in Polymeric Fibers (2001), 225-246. Editor(s): Salem, David R. Publisher: Carl Hanser Verlag, Muenchen, Germany; Grafe, Timothy; Graham, Kristine, Conference Proceedings—Joint INDA-TAPPI Conference, Atlanta, Ga., United States, Sep. 24-26, 2002 (2002), 224-236 Publisher: INDA, Association of the Nonwoven Fabrics Industry, Cary, N. C.; Zhao, Shengli; Huang, Yong, Xianweisu Kexue Yu Jishu (2002), 10(3), 53-59; Frenot, Audrey; Chronakis, Ioannis S., Current Opinion in Colloid & Interface Science (2003), 8(1), 64-75; An, Linhong; Wang, Yue, Dangdai Shiyou Shihua (2002), 10(1), 41-45; Grafe, Timothy; Graham, Kristine, International Nonwovens Journal (2003), 12(1), 51-55; Son, Won-Keun; Park, Won-Ho; Nam, Young-Sik; Son, Won-Keun, Kobunja Kwahak Kwa Kisul (2003), 14(3), 274-286; Boland, Eugene D.; Simpson, David G.; Wnek, Gary E.; Bowlin, Gary L., Polymer Preprints (American Chemical Society, Division of Polymer Chemistry) (2003), 44(2), 92-93; Huang, Zheng-Ming; Zhang, Y.-Z.; Kotaki, M.; Ramakrishna, S., Composites Science and Technology (2003), 63(15), 2223-2253; Luzhansky, Dmitry M., INTC 2003, International Nonwovens Technical Conference, Conference Proceedings, Baltimore, Md., United States, Sep. 15-18, 2003 (2003), 468-474 Publisher: INDA, Association of the Nonwoven Fabrics Industry, Cary, N. C.; Huang, Meirong; Li, Xingui; Zeng, Jianfeng; Zhang, Wei, Xiandai Huagong (2002), 22(12), 10-13, 22; Li, Dan; Wang, Yuliang; Xia, Younan, Advanced Materials (Weinheim, Germany) (2004), 16(4), 361-366; Greiner, Andreas; Wendorff, Joachim H.; Steinhart, Martin, Nachrichten aus der Chemie (2004), 52(4), 426-431; Lyons, Jason; Ko, Frank K., Encyclopedia of Nanoscience and Nanotechnology (2004), Volume 6, 727-738. Editor(s): Nalwa, Hari Singh. Publisher: American Scientific Publishers, Stevenson Ranch, Calif.; Dai, Liming, Encyclopedia of Nanoscience and Nanotechnology (2004), Volume 8, 763-790. Editor(s): Nalwa, Hari Singh. Publisher: American Scientific Publishers, Stevenson Ranch, Calif.

One of the major problems with forming filaments from conducting polymers by electrospinning is the requirement for the polymer to be soluble in some convenient solvent. The vast majority of conducting polymers are insoluble, or require complicated and costly processes to make them soluble. Such filament formation is therefore restricted to a few examples. These involve modification of the polymer backbone or the introduction of a solubilising dopant to the polymer in order to render it soluble.

The polymer solution is placed in a hypodermic syringe in front of a copper sheet target. A positive terminal is attached to the metal needle of the syringe (anode) and a negative terminal is attached to the target (cathode). A voltage differential is applied across the electrodes.

The polymer solution is allowed to drip out of the syringe and a voltage is applied. Flash evaporation of the solvent occurs and continuous polymer filaments or nano-fibres are formed and travel to the cathode target. Depending on the conditions used filaments and nano-fibres of many metres length can be collected.

The procedures for solubilising the otherwise insoluble polymer add to the cost of preparing polymer filaments and can significantly alter the properties of the final material. As many polymers are insoluble, the utility of electrospinning as a general method for the preparation of polymer filaments is limited.

A process of making conductive polymeric fibers by electrospinning fibers from a blend of polymers dissolved in an organic solvent is described in United States patent application no. 2003/137083. It is desirable to provide a method of producing polymer filaments that avoids the need to solubilise a preformed polymer and is applicable to the preparation of a range of polymer filaments, especially filaments of conducting polymers that are insoluble.

The object of this invention is to provide a method for producing polymer filaments by electrospinning using solutions of polymerisable monomer units, or to at least provide the public with a useful choice.

### STATEMENT OF INVENTION

Accordingly, in a first aspect the invention consists in a method of electrospinning including the use of a solution including:
a first polymerisable oxidizable monomer;
an oxidant; and
at least one solvent component;

where the at least one solvent component is present at a concentration sufficient substantially to inhibit oxidation of the polymerisable unit by the oxidant.

Preferably the solution additionally includes a solubilised polymer.

Preferably the solution includes a second polymerisable monomer.

Preferably the polymerisable oxidizable monomer is selected from the group including:

Pyrrole and its derivatives;
Pyrrole, pyrrole dimer, 3,3′-dimethyl-2,2′-bipyrrole-4,4′-dicarboxylic acid distearyl ester, 3,3′-dimethyl-2,2′-bipyrrole-4,4′-dicarboxylic acid dihexyl ester, 3,3′-dimethyl-2,2′-dithiophene, 3,3′-dihexyl-2,2′-dithiophene, 4-methylpyrrole-3-carboxylic acid, 4-phenylpyrrole-3-carboxylic acid, 4-methylpyrrole-3-carboxylic acid methyl ester, 4-methylpyrrole-3-carboxylic acid ethyl ester, 4-n-propylpyrrole-3-carboxylic acid methyl ester, 4-n-propylpyrrole-3-carboxylic acid ethyl ester, pyrrole-3-carboxylic acid methyl ester, 3-methylpyrrole, 3-hexylpyrrole, pyrrole-3-carboxylic acid, 4-methylpyrrole-3-carboxylic acid hexyl ester, 4-benzylpyrrole-3-carboxylic acid methyl ester, 4-methylpyrrole-3-carboxylic acid dodecyl ester, pyrrole-3-carboxylic acid stearyl ester, 4-phenylpyrrole-3-carboxylic acid stearyl ester, 3-phenylpyrrole, 3-acetopyrrole, 3-undecylcarbonylpyrrole, 3-aminomethyl-4-methylpyrrole, 3-aminomethyl-4-phenylpyrrole, 3-acetoaminomethyl-4-phenylpyrrole, 3-benzoylpyrrole, 3-methyl-4-dimethylaminocarbamoylpyrrole, 3-methyl-4-dimethylaminomethylpyrrole, 4-methylpyrrole-3-carboxylic acid phenyl ester, 4-methylpyrrole-3-carboxylic acid benzyl ester, 4-methylpyrrole-3-carboxylic acid 4-phenylazophenyl ester, 4-methylpyrrole-3-carboxylic acid 16-bromo-2,3,5,6,8,9,11,12-octahydro-1,4,7,10,13-benzopentaoxacyclopentadecin-15-ylmethyl ester, etc.
Thiophene and Its Derivatives:
Thiophene; alkyl substituted thiophenes such as 3-methylthiophene; halogen substituted thiophenes such as 3-bromothiophene; polyether substituted thiophenes such as 3-methoxydiethoxymethylthiophene; aryl substituted thiophenes such as 3-phenylthiophene, 3-benzylthiophene, 3-methyl-4-phenylthiophene, 2,3′-bithiophene, 2,2′-bithiophene, 2,2′,2″-terthiophene; azo substituted thiophenes, bithiophenes and terthiophenes; amine (primary and secondary) substituted thiophenes, bithiophenes and terthiophenes; carbonyl substituted thiophenes, bithiophenes and terthiophenes; formyl substituted thiophenes, bithiophenes and terthiophenes; styryl substituted thiophenes, bithiophenes and terthiophenes; alkyl substituted thiophenes, bithiophenes and terthiophenes; alkoxy substituted thiophenes, bithiophenes and terthiophenes; pyridyl substituted thiophenes, bithiophenes and terthiophenes; EDOT (3,4 ethylenedioxythiophene) and derivatives.
Aromatic Amine and Its Derivatives:
Aniline, N-monosubstituted anilines (whose substituents include an alkyl, phenyl, p-aminophenyl, N-monoalkylaminophenyl, N-monophenylaminophenyl and N-monophenylaminodiphenyl, etc.), substituted anilines [whose substituents include o-amino, amino p-(p-aminophenoxy), p-(p-aminophenyl), etc.], polycyclic condensed aromatic amines such as naphthylamine and perylene, etc. These aromatic amines may have a substituent on the benzene ring.
Others:
Benzene, diphenyl, naphthalene, anthracene, azulene, carbazol, benzothiophene, etc. These may have substituents.

Most preferably the polymerisable oxidizable monomer provides an insoluble polymer.

Preferably the oxidant is selected from the group including:
FeCl₃, CuCl₂, Fe(NO₃)₃, SbCl₅, MoCl₅, FeClO₄, FeOTs, CuClO₄ and CuOTs, or their hydrates or their mixtures, where ‘Ts’ is tosylate (p-toluenesulfonate)

Preferably the at least one solvent component is selected from the group including:
alcoholic solvents such as methanol, ethanol and isopropanol; ethers such as diethylether; ketones such as methylethylketone; acids such as acetic acid and propionic acid; aldehydes; amines (primary, secondary and tertiary) such as triethylamine.

Preferably the oxidant and at least one solvent component are FeCl₃ and MeOH, respectively.

Preferably the solubilised polymer is selected from the group of soluble polymers including:
Polycetals such as polyoxymethylene; polyacrylics such as polymethylmethacrylate (PMMA); amino resins such as polyureaformaldehyde; cellulosics such as cellulose acetate, cellulose nitrate, cellulose propionate, cellulose acetate butyrate and ethyl cellulose; polyphenolics such as “phenolic” itself; polyamides such as nylon; polyesters such as “polyester” itself; polyolefins; polyurethanes such as “polyurethane” itself; polystyrenes such as “polystyrene” itself; vinyls; polyethylene oxide (PEO).

Most preferably the solubilised polymer is a conducting polymer.

Preferably the polymerisable oxidizable monomer is present in the solution at a concentration in the range 0.5 to 2M, most preferably around 1M.

Preferably a portion of the polymerisable oxidizable monomer is present in the form of soluble oligomers.

Preferably the oxidant is present in the solution at a concentration in the range 0.2 to 2M most preferably around 0.2M.

Preferably the at least one solvent component is present in the solution at a concentration around 37% (v/v).

Preferably the solution additionally includes a solubilised polymer at a concentration around 1.5% (v/v).

In a first embodiment of the invention a method of electrospinning is provided including the use of a solution including:

1M pyrrole, 0.25M FeCl₃ (anhydrous) and 3% w/w PEO (molecular weight 900 000 g/mol) in 4:1 CHCl₃:MeOH (v/v).

In a second embodiment of the invention a method of electrospinning is provided including the use of a solution including:

1M 3,4 ethylenedioxythiophene (EDOT), 0.20M FeCl₃ (anhydrous) and 1.5% w/w PEO (molecular weight 900 000 g/mol) in 2.7:1 CHCl₃:MeOH (v/v).

In a third embodiment of the invention a method of electrospinning is provided including the use of a solution including:

1M pyrrole, 0.25M FeCl₃ (anhydrous) in 4:1 CHCl₃:MeOH (v/v).

In a second aspect the invention consists in a polymer filament prepared by the method of the first aspect of the invention.

In a third aspect the invention may broadly be said to consist in a polymer filament of polypyrrole.

Preferably the polymer of the polymer filament is selected from the group including: polypyrrole and poly(3,4 ethylene dioxythiophene) (PEDOT).

Preferably the polymer of the polymer filament is a blend. Most preferably the polymer filament is a blend of polypyrrole and polyethylene oxide (PEO) or poly(3,4 ethylene dioxythiophene) (PEDOT) and polyethylene oxide (PEO).

In a fourth aspect the invention may broadly be said to consist in a method of producing a polymer filament including the steps:
Providing a first electrode and a second electrode spaced apart where the first electrode includes at least one orifice and the second electrode includes a target surface;
placing a solution as defined in the first aspect of the invention in the orifice included in the first electrode;
applying a high electrical potential difference to and between the first electrode and the second electrode; and
collecting the polymer filaments formed.

Preferably the first electrode is an anode and the second electrode is a cathode.

In a first embodiment the polymer filaments are collected at the target surface included in the second electrode.

In a second embodiment the polymer filaments are collected at a surface placed between the first electrode and the second electrode.

### BRIEF DESCRIPTION OF THE DRAWINGS

FIG. 1. Individual polypyrrole/PEO fiber (×100 magnification).

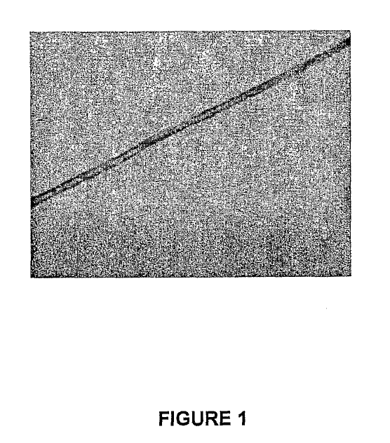

### DETAILED DESCRIPTION

Currently, most synthetic fibres are created by extrusion. Polymer in liquid form is forced through a network of tiny holes (a spinneret) to form continuous filaments of semi-solid polymer.

In their initial state, the fibre-forming polymers are solids and therefore must be converted into a fluid state for extrusion. This is usually achieved by melting, if the polymers are thermoplastic synthetics, or by dissolving them in a suitable solvent. If the polymers cannot be melted or dissolved directly, they must be chemically treated to form thermoplastic or soluble derivatives.

Recent technologies have been developed for some specialty fibres made of polymers that do not melt, dissolve, or form appropriate derivatives. For these materials, the monomers, or polymer components, are mixed and reacted to form the otherwise intractable polymers during the extrusion process.

There are four methods of spinning filaments of manufactured fibres: wet, dry, melt, and gel spinning. All are based on extrusion of the polymer.

Wet spinning is the oldest process. It is used for polymers that have been dissolved in a solvent. The spinnerets are submerged in a chemical bath and as the filaments emerge they precipitate from solution and solidify.

Dry spinning is also used for polymers in solution. However, instead of precipitating the polymer by dilution or chemical reaction, solidification is achieved by evaporating the solvent in a stream of air or inert gas.

In melt spinning, the polymer is melted for extrusion through the spinneret and then directly solidified by cooling.

Gel spinning is a special process used to obtain high strength or other special fibre properties. The polymer is not in a true liquid state during extrusion, but in liquid crystal form. The resulting filaments have strong inter-chain forces and emerge with an unusually high degree of orientation relative to each other. This significantly increases the tensile strength of the fibres. The process can also be described as dry-wet spinning, since the filaments first pass through air and then are cooled further in a liquid bath.

Electrospinning has been used to form polymer fibres, particularly of very small diameter (<5 nm). However, as stated these methods of preparing polymer filaments all rely on polymers that are soluble, meltable, or derivatisable.

In the method of the invention described here, polymer filaments are prepared using a mixture of a polymerisable oxidizable monomer unit and an oxidising agent in solution, where the solvent also acts as an inhibitor of the extent of polymerisation. In this method solvent is rapidly removed (flash vaporisation) once polymerisation of the polymerisable oxidizable monomer units has been initiated.

Whilst not wishing to be bound by theory it is contemplated that in the method of the invention the formation of polymer filaments is favoured by the formation of oligomers in the solution prior to flash vaporisation. In one example, substantial polymerisation is inhibited by the use of methanol as solvent when ferric chloride is used as the oxidising agent.

The inventors have determined that by the selection of appropriate oxidising agent and solvent component combinations it is possible to control the extent of polymerisation until removal of solvent occurs. By the method of the invention the preparation of polymer filaments from solutions of polymerisable oxidizable monomer units is permitted.

This basic method of producing polymer filaments may be further improved by the addition of preformed polymer at low concentrations, i.e. without precipitation. These preformed polymers may also facilitate and promote the formation of filaments.

The method of preparing conducting polymer filaments in accordance with the method of the invention will now be illustrated by reference to examples.

In Example 1 and Example 2 conducting polymer filaments are formed by pumping or drawing the mixture of polymerisable monomer and oxidising agent in solution through an orifice provided by a syringe so that as the solution exits the orifice the solvent rapidly evaporates allowing conducting polymer filaments to be formed on a target surface.

Control of the deposition of conducting polymer filaments on the target surface is achieved by controlling the rate at which the mixture exists the orifice, the pressure in the region between the exit of the orifice and the target surface, and the electrical potential applied to and between the exit of the orifice and the target surface.

### EXAMPLE 1

A Procedure for the Production of Polypyrrole/Polyethylene Oxide (PEO) Filaments.

A solution of 1M pyrrole, 0.25M FeCl₃ (anhydrous) and 3% w/w PEO (molecular weight 900 000 g/mol) in 4:1 CHCl₃:MeOH (v/v) was prepared. The solution was stirred at room temperature for 5 minutes and filtered through a 0.45 μm filter prior to electrospinning.

1 mL of this solution was placed in a hypodermic syringe, the needle of which was placed 30 cm from a 10 cm diameter circular copper sheet target electrode. The positive electrode (anode) of a variable high voltage DC power supply was attached to the metal needle of the syringe and the negative terminal was attached to the copper target electrode. A 30 kV differential was applied across the electrodes.

The solution was allowed to drip out of the syringe needle tip. The solvent droplet deformed and a jet of solvent and polymer was created at the droplet surface. Flash evaporation of the solvent occurred and black polymer fibres were formed and accumulated at the cathode target. The fibres were washed with MeOH to remove iron species and water.

Individual fibres were collected by passing a microscope slide or silicon wafer between the electrodes, through the path of the fibres. These fibres were examined by microscopy and found to be approximately 500 nm in diameter.

Pads of these fibres on glass slides had a measured electrical resistance of 10 kΩ indicating appreciable fibre conductivity. By comparison, PEO fibres prepared identically to this, but in the absence of monomer, showed no measurable conductivity as evidenced by resistance measurements.

### EXAMPLE 2

A Procedure for the Production of Poly(3,4-Ethylenedioxythiophene) (PEDOT)/Polyethylene Oxide (PEO) Filaments

A solution of 1M 3,4 ethylenedioxythiophene (EDOT), 0.20M FeCl₃ (anhydrous) and 1.5% w/w PEO (molecular weight 900 000 g/mol) in 2.7:1 CHCl₃:MeOH (v/v) was prepared. The solution was stirred at room temperature for 5 minutes and filtered through a 0.45 μm filter prior to electrospinning.

1 mL of this solution was placed in a hypodermic syringe, the needle of which was placed 30 cm from a 10 cm diameter circular copper sheet target electrode. The positive electrode (anode) of a variable high voltage DC power supply was attached to the metal needle of the syringe and the negative terminal was attached to the copper target electrode. A 30 kV differential was applied across the electrodes.

The solution was allowed to drip out of the syringe needle tip. The solvent droplet deformed and a jet of solvent and polymer was created at the droplet surface. Flash evaporation of the solvent occurred and bright blue polymer fibres were formed and accumulated at the cathode target. The fibres were washed with MeOH to remove iron species and water.

Individual fibres were collected by passing a microscope slide or silicon wafer between the electrodes, through the path of the fibres. These fibres were examined by microscopy and found to be approximately 1 μm in diameter.

Pads of these fibres on glass slides had a measured electrical resistance of 60 kΩ indicating appreciable fibre conductivity. By comparison, PEO fibres prepared identically to this, but in the absence of monomer showed no measurable conductivity as evidenced by resistance measurements.

The invention has the advantage of providing for the preparation of a broad range of polymer filaments including polymers that cannot be solubilized.

The invention has the further advantage of providing polymer filaments with specific characteristics. The characteristics of filament diameter and length can be controlled by altering parameters such as the spacing apart of the first electrode and the second electrode, the composition of the solution, the magnitude of the high electrical potential difference, the pressure maintained in the region between the orifice and the target surface, and the distance from the orifice to the target surface where the filaments are collected. Doping of the polymer filament to import novel characteristics is also provided for.

### INDUSTRIAL APPLICABILITY

The conducting polymers filaments produced by the method of the invention have use in a number of applications. These include uses as “molecular wires” for the development of nano-scale electronic devices, and “mats” for the development of high surface area electrodes for sensor and photovoltaic applications. Particular advantages accrue where soluble forms of the polymer for use in these applications are not available.

Where in the foregoing description reference has been made to integers or components having known equivalents then such equivalents are herein incorporated as if individually set forth.

Although the invention has been described by way of example and with reference to possible embodiments thereof it is to be appreciated that improvements and/or modification may be made thereto without departing from the scope or spirit of the invention.

What we claim is:

1. A method of electrospinning including the use of a solution including:
a. a first polymerisable oxidizable monomer;
b. an oxidant; and
c. at least one solvent component;
where the at least one solvent component is present at a concentration sufficient substantially to inhibit oxidation of the monomer by the oxidant.

2. A method according to claim 1 where the solution includes a solubilised polymer.

3. A method according to claim 1 where the solution includes a second polymerisable oxidizable monomer.

4. A method according to claim 1 where the polymerisable oxidizable monomer is selected from the group including:
pyrrole and its derivatives including;
pyrrole, pyrrole dimer, 3,3′-dimethyl-2,2′-bipyrrole-4,4′-dicarboxylic acid distearyl ester, 3,3′-dimethyl-2,2′-bipyrrole-4,4′-dicarboxylic acid dihexyl ester, 3,3′-dimethyl-2,2′-dithiophene, 3,3′-dihexyl-2,2′-dithiophene, 4-methylpyrrole-3-carboxylic acid, 4-phenylpyrrole-3-carboxylic acid, 4-methylpyrrole-3-carboxylic acid methyl ester, 4-methylpyrrole-3-carboxylic acid ethyl ester, 4-n-propylpyrrole-3-carboxylic acid methyl ester, 4-n-propylpyrrole-3-carboxylic acid ethyl ester, pyrrole-3-carboxylic acid methyl ester, 3-methylpyrrole, 3-hexylpyrrole, pyrrole-3-carboxylic acid, 4-methylpyrrole-3-carboxylic acid hexyl ester, 4-benzylpyrrole-3-carboxylic acid methyl ester, 4-methylpyrrole-3-carboxylic acid dodecyl ester, pyrrole-3-carboxylic acid stearyl ester, 4-phenylpyrrole-3-carboxylic acid stearyl ester, 3-phenylpyrrole, 3-acetopyrrole, 3-undecylcarbonylpyrrole, 3-aminomethyl-4-methylpyrrole, 3-aminomethyl-4-phenylpyrrole, 3-acetoaminomethyl-4-phenylpyrrole, 3-benzoylpyrrole, 3-methyl-4-dimethylaminocarbamoylpyrrole, 3-methyl-4-dimethylaminomethylpyrrole, 4-methylpyrrole-3-carboxylic acid phenyl ester, 4-methylpyrrole-3-carboxylic acid benzyl ester, 4-methylpyrrole-3-carboxylic acid 4-phenylazophenyl ester, 4-methylpyrrole-3-carboxylic acid 16-bromo-2,3,5,6,8,9,11,12-octahydro-1,4,7,10,13-benzopentaoxacyclopentadecin-15-ylmethyl ester;
thiophene and its derivatives including:
thiophene; alkyl substituted thiophenes such as 3-methylthiophene; halogen substituted thiophenes such as 3-bromothiophene; polyether substituted thiophenes such as 3-methoxydiethoxymethylthiophene; aryl substituted thiophenes such as 3-phenylthiophene, 3-benzylthiophene, 3-methyl-4-phenylthiophene, 2,3′-bithiophene, 2,2′-bithiophene, 2,2′,2″-terthiophene; azo substituted thiophenes, bithiophenes and terthiophenes; amine (primary and secondary) substituted thiophenes, bithiophenes and terthiophenes; carbonyl substituted thiophenes, bithiophenes and terthiophenes; formyl substituted thiophenes, bithiophenes and terthiophenes; styryl substituted thiophenes, bithiophenes and terthiophenes; alkyl substituted thiophenes, bithiophenes and terthiophenes; alkoxy substituted thiophenes, bithiophenes and terthiophenes; pyridyl substituted thiophenes, bithiophenes and terthiophenes; EDOT (3,4 ethylenedioxythiophene) and derivatives.
aromatic amine and its derivatives including:
aniline, N-monosubstituted anilines (whose substituents include an alkyl, phenyl, p-aminophenyl, N-monoalkylaminophenyl, N-monophenylaminophenyl and N-monophenylaminodiphenyl, etc.), substituted anilines [whose substituents include o-amino, amino p-(p-aminophenoxy), p-(p-aminophenyl), etc.], polycyclic condensed aromatic amines such as naphthylamine and perylene, etc. These aromatic amines may have a substituent on the benzene ring; and
others including:
benzene, diphenyl, naphthalene, anthracene, azulene, carbazol, benzothiophene. These may have substituents.

5. A method according to claim 1 where the polymerisable oxidizable monomer provides an insoluble polymer.

6. A method according to claim 1 where the oxidant is selected from the group including:
FeCl₃, CuCl₂, Fe(NO₃)₃, SbCl₅, MoCl₅, FeClO₄, FeOTs, CuClO₄ and CuOTs, or their hydrates or their mixtures.

7. A method according to claim 1 where the at least one solvent component is selected from the group including:
alcoholic solvents such as methanol, ethanol and isopropanol; ethers such as diethylether; ketones such as methylethylketone; acids such as acetic acid and propionic acid; aldehydes; amines (primary, secondary and tertiary) such as triethylamine.

8. A method according to claim 1 where the oxidant and at least one solvent component are FeCl₃ and MeOH, respectively.

9. A method according to claim 1 where the solubilised polymer is selected from the group of soluble polymers including:
polycetals such as polyoxymethylene; polyacrylics such as polymethylmethacrylate (PMMA); amino resins such as polyureaformaldehyde; cellulosics such as cellulose acetate, cellulose nitrate, cellulose propionate, cellulose acetate butyrate and ethyl cellulose; polyphenolics such as “phenolic” itself; polyamides such as nylon; polyesters such as “polyester” itself; polyolefins; polyurethanes such as “polyurethane” itself; polystyrenes such as “polystyrene” itself; vinyls; polyethylene oxide (PEO).

10. A method according to claim 1 where preferably the solubilised polymer is a conducting polymer.

11. A method according to claim 1 where the polymerisable oxidizable monomer is present in the solution at a concentration in the range 0.5 to 2M.

12. A method according to claim 1 where the polymerisable oxidizable monomer is present in the solution at a concentration around 1M.

13. A method according to claim 1 where a portion of the polymerisable oxidizable monomer is present in the form of oligomers.

14. A method according to claim 1 where the oxidant is present in the solution at a concentration in the range 0.2 to 2M

15. A method according to claim 1 where the oxidant is present in the solution at a concentration around 0.2M.

16. A method according to claim 1 where the at least one solvent component is present in the solution at a concentration around 37% (v/v).

17. A method according to claim 1 where the solution additionally includes a solubilised polymer at a concentration around 1.5% (v/v).

18. A method according to claim 1 including the use of a solution including:
1M pyrrole, 0.25M FeCl₃ (anhydrous) and 3% w/w PEO (molecular weight 900 000 g/mol) in 4:1 CHCl₃:MeOH (v/v).

19. A method according to claim 1 including the use of a solution including:
1M 3,4 ethylenedioxythiophene (EDOT), 0.20M FeCl₃ (anhydrous) and 1.5% w/w PEO (molecular weight 900 000 g/mol) in 2.7:1 CHCl₃:MeOH (v/v).

20. A method according to claim 1 including the use of a solution including:
1M pyrrole and 0.25M FeCl₃ (anhydrous) in 4:1 CHCl₃:MeOH (v/v).

21. A polymer filament prepared by the method according to any one of claims 1 to 20.

22. A polymer filament of polypyrrole or poly (3,4 ethylene dioxythiophene) (PEDOT).

23. A polymer filament of polypyrrole.

24. A polymer filament that is a blend of polypyrrole and polyethylene oxide (PEO) or poly (3,4 ethylene dioxythiophene) (PEDOT) and polyethylene oxide (PEO).

25. A method of producing a polymer filament including the steps:
a. Providing a first electrode and a second electrode spaced apart where the first electrode includes at least one orifice and the second electrode includes a target surface;
b. placing a solution as defined in the any one of claims 1 to 20 in the orifice included in the first electrode;
c. applying a high electrical potential difference to and between the first electrode and the second electrode; and
d. collecting the polymer filaments formed.

26. A method according to claim 25 where the first electrode is an anode and the second electrode is a cathode.

27. A method according to claim 25 where the polymer filaments are collected at the target surface included in the second electrode.

28. A method according to claim 25 where the polymer filaments are collected at a surface placed between the first electrode and the second electrode.
